(19) United States
(12) Patent Application Publication
(10) Pub. No.: US 2018/0265140 A1
(43) Pub. Date: Sep. 20, 2018

(54) Gate Lift

(71) Applicant: Adam NAPOLI, Christmas Hills (AU)

(72) Inventor: Adam NAPOLI, Christmas Hills (AU)

(21) Appl. No.: 15/541,311

(22) PCT Filed: Dec. 11, 2015
(86) PCT No.: PCT/AU2015/000753

§ 371 Date: Jun. 30, 2017

(30) Foreign Application Priority Data
Dec. 11, 2014 (AU) 2014905022

(51) Int. Cl. B62D 33/03; B62D 33/037; E05F 15/53

(52) U.S. Cl. CPC B62D 33/03; B62D 33/037; E05Y 2900/544; E05Y 2900/516; E05F 15/53

(57) ABSTRACT

A gate lift (22) for pivotally raising and lowering a pivoting opening (12). The gate lift is for pivotally raising and lowering a gate and comprises a linear drive able to extend and retract linearly and having a pulley line connectable to the gate at a position spaced from the axis of the pivot of the gate and extending from the linear drive.

### FIELD OF THE INVENTION

The present invention relates to gate lift and in particular to a gate lift for a vehicle such as a tray truck, tip truck or a railway truck or other flatbed vehicle or tipper tailgate.

The invention has been developed primarily for use in/with gate for a vehicle and will be described hereinafter with reference to this application. However, it will be appreciated that the invention is not limited to this particular field of use. For example the gate lift can be used for the opening in a side of a building or receiving goods or in other situations where a gate is pivotally mounted in particular the rotation between the politically upwardly extending close position and they downwardly extending open position.

### BACKGROUND OF THE INVENTION

Generally on flatbed vehicles, such as tray trucks, inside lateral gates can be mounted alongside the flatbed along a horizontal pivot axis and require the use of the vehicle to unlock and then rotate the lateral gate around pivot axis. However such movement can result in loss of control of the opening of the lateral gate and therefore injury to the person who is opening the gate or others who are accidentally nearby. Another injury can be the result of unexpected jamming of fingers all lemons between the large opening lateral gate and adjacent vehicle structure. A further injury can be due to weight considerations and stretching considerations that cause back injuries of the person who is opening or closing the gate.

A still further detriment of a normal mechanically rotated gate is the oversight in either locking or unlocking the gate between times of opening or closing of the gate. This can result in the accidental falling of the gate of a person nearby. Further it can result in the loss of a load from the flatbed vehicle as it progresses along a road due to the load no longer being restrained or withheld within the flatbed by the side lateral gate.

It could be said that such problems can be readily overcome by merely adding an automatic opening and closing mechanism to the lateral gates surrounding the flatbed of the flatbed vehicle. However it is not acceptable to include a complex crane mechanism.

It is shown in U.S. Pat. No. 5,449,212 an electrically-controlled tailgate operator for moving a vehicle tailgate between a generally vertical raised position and a generally horizontal lowered position. The tailgate operator includes a ball nut linear actuator received in a housing mounted longitudinally along the side of a vehicle. The actuator includes a rotatable, horizontally-extending externally-threaded worm screw, an internally-threaded ball nut in threaded engagement with the worm screw for linear movement relative to the worm screw, and a sheave attached to the ball nut and around which a flexible cable is routed. A motor is coupled to the worm screw. The flexible cable is attached at one end to the vehicle tailgate, and at its other end to the housing. When the motor is activated to rotate the worm screw in a first direction around its axis, the ball nut moves linearly toward the tailgate and the cable extends outwardly toward the tailgate, thereby moving the tailgate to a generally horizontal lowered position. When the motor is reversibly operated to rotate the worm screw in a second direction around its axis opposite the first direction, the ball nut is pulled back toward the front of the vehicle, thereby pulling the cable back toward the vehicle and moving the tailgate to a generally vertical raised position.

However this device is unable to extend beyond 90 degrees and requires a catching line to ensure it stays within the 90 degrees. It also requires a substantial fixed length that must extend self-supporting manner yet hold the weight of the tailgate. Further the system creates complex angular stresses and strains due to the interaction of the angularly downwardly forces of flexible cable on the ball nut which engages rotating worm gear. Generally the system cannot be used for a side wall of a truck flatbed.

In US Patent Application No. 2010/0109368 there is shown a power operated retractable tailgate assembly for a vehicle that includes a tailgate with opposite end edges thereof connected via sliding pivots to a respective one of a pair of elongate slide rails. The slide rails mount in lateral spaced apart relation on the underside of the floor of the cargo carrying box on the vehicle. A first extendible and retractable assembly, having relatively movable respective first and second portions, has the first portion anchored to the vehicle and a second portion that is hingedly connected to the tailgate proximate a lower marginal edge thereof. A power means is operatively connected to the extendible and retractable assembly and is operable from within the cab of the vehicle selectively to extend and retract the tailgate by moving the tailgate along the slide members. A second power operated extendible and retractable assembly is connected to the tailgate to move the same from its open position wherein it is horizontally disposed and projects rearwardly from the vehicle to a raised closed position wherein it is disposed vertically. Each of the extendable and retractable assemblies include a hydraulic cylinder unit operatively associated with a motor-driven pump. An alternate method of opening and closing the tailgate uses an electric motor directly driving a cable system which opens and closes the tailgate utilizing for example a winch unit comprising an electric motor driving a cable drum rather than the use of a screw drive or hydraulic means to control the cables.

It can be seen that such a system is substantially only available for a tailgate and not for a side wall. Further it is not possible to extend over 90 degrees in opening as then the cable raps around the pivot of the tailgate. Further the mechanism needs mounting at various levels and at various locations to create an apparatus hat is not possible on a flatbed truck.

In U.S. Pat. No. 6,382,731 there is shown a load hauling vehicle such as a truck or trailer having a bed which can be loaded or unloaded either from the side or the rear of the bed. A typical vehicle such as a trailer shown herein has a tail gate which can be opened and has one or both side walls which are hinged at the bottom edge to an adjacent edge of the bottom of the bed so that the sidewalls can be swung by a power activated linkage assembly, from an upwardly extending closed position to a downwardly extending open position. The trailer bed can also be tilted upwardly and rearwardly in the manner of a typical dump truck to empty a load out the back end of the trailer bed when the tail gate is released to open. The trailer bed can be raised to a dump position by a typical hydraulic actuator.

It can be seen that this device requires complex linkage systems with exact precisions and generally due to minor misalignments do not function in the practical world.

Therefore, the problems of the prior art include:
a) need for a mechanism which takes a substantial amount of the storage area of the flatbed so that smaller loads can only be transported by the flatbed vehicles.
b) Further a flatbed vehicle is limited in its width according to road laws and size of road structures. Therefore solutions to date have not been acceptable to the industry;
c) Systems generally are not sized and effective to open side walls of a flatbed truck;
d) Need for system to be compact, streamline and simple for installation;
e) Systems generally do not allow for opening greater than 90 degrees and particularly not allowing about 180 degree openings;
f) Systems cannot be readily closed if opened over 90 degrees; and
g) Complex linkage systems require exact precisions and generally due to minor misalignments do not function in the practical world.

The present invention seeks to provide a gate lift, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a gate lift for pivotally raising and lowering a gate comprising a linear drive; wherein the linear drive is able to extend and retract linearly, whereby, in use, the gate lift mounted substantially orthogonally to the plane of the pivotal mount of the lateral gates can move the lateral gates between a first closed position to a second open position.

Preferably the gate lift for pivotally raising and lowering a gate which includes a linear pulley providing a pulley line extending from an overhang and connectable to the gate at a position spaced from the axis of the pivot of the gate; wherein the linear drive is able to drive the linear pulley relative to the housing so as to extend and retract linearly to and from an over pivot position, whereby, in use, the gate lift mounted substantially orthogonally to the plane of the pivotal mount of the lateral gates can move the lateral gates greater than 90 degrees between a first closed position and a second open position.

Preferably the gate lift for pivotally raising and lowering a gate wherein the end of the pulley line extends and retracts beyond the intermediate part of the linear pulley at a distance which is a multiple of a stroke distance of the extension and retraction linearly of the linear drive.

In one form the invention provides a gate lift for pivotally raising and lowering a gate comprising a housing mountable on a solid base; a linear drive having a casing fixedly mounted relative to the housing; a linear pulley having a slide with at least one pulley wheel at either end and an intermediate part mounted to a slide rail which is fixedly mounted relative to the housing to allow relative sliding movement of the linear pulley relative to the housing; a pulley line extending from the linear drive casing and around the pulley wheels and connectable to the gate at a position spaced from the axis of the pivot of the gate; wherein the linear drive is able to drive the linear pulley relative to the housing so as to extend and retract linearly; whereby, in use, the gate lift mounted substantially orthogonally to the plane of the pivotal mount of the lateral gates can move the lateral gates between a first closed position to a second open position.

The housing can be an angle section.

Preferably the casing of the linear drive acts as the housing.

Preferably the linear drive is a piston drive. The piston drive can include a piston chamber fixedly mounted relative to the housing.

In the gate lift the intermediate part of the linear pulley can have a slide with a pulley wheel mounted at either end at fixed spacing. The stroke of the piston rod of the piston can drive the slide of the intermediate part of the linear pulley. Preferably the end of the piston rod of the piston is connected to the intermediate part of the linear pulley.

In the gate lift the end of the pulley line can extend and retract beyond the intermediate part of the linear pulley at a distance greater than the stroke of the piston rod of the linear drive.

Preferably the end of the pulley line extends and retracts beyond the intermediate part of the linear pulley at a distance which is a multiple of the stroke of the piston rod of the linear drive.

Preferably the end of the pulley line extends from the piston chamber and around the pulley wheel at end of the intermediate part of the linear pulley to thereby extend beyond the intermediate part of the linear pulley at a distance substantially corresponding to twice the stroke of the piston rod of the linear drive.

Preferably the end of the pulley line extends from the piston chamber and around the pulley wheels at end of the intermediate part of the linear pulley more than once to thereby extend the pulley line beyond the intermediate part of the linear pulley at a distance greater than twice the stroke of the piston rod of the linear drive.

Also the invention provides a gate lift system including a gate mounted pivotally raising and lowering a gate comprising: a flatbed, a lateral gate mounted pivotally along a side of the flatbed; and a gate lift for pivotally raising and lowering the lateral gate.

The gate can be mountable to a vehicle. The gate can be mountable to a tray of a truck or train. The gate can also be mounted to a tipper tailgate.

The gate can be mountable to a building.

Still further the invention can provide a method of pivotally raising and lowering a gate including the steps of:
a) mounting the gates in a pivotal manner
b) providing a linear drive
c) providing a linear pulley
d) mounting the linear pulley so as to extend and retract linearly substantially orthogonally to the plane of the pivotal mount of the gates in a first closed position and from one side to an over pivot position on the other of the orthogonal plane of the pivotal mount of the gates;
e) connecting a pulley line from the linear drive pulley to the gate at a position spaced from the axis of pivotal of the gate
   whereby, in use, the gate lift mounted substantially orthogonally to the plane of the pivotal mount of the lateral gates can move the lateral gates greater than 90 degrees between a first closed position and a second open position.

It can be seen that the invention of a gate lift provides one or more of the benefits of:
i) allowing ready opening and closing of lateral gates of a flatbed;
ii) does not take substantial area of the flatbed or causing inconvenient overhangs by crane arrangements.
iii) further a flatbed vehicle is limited in its width according to road laws and size of road structures. The present invention with its stroke and overlap configuration can take up only half the width of a vehicle and thereby have two gate lifts in a single width readily opening opposing lateral walls of the flatbed truck.
iv) the system is compact and streamline as there are only two overlapping elongated bodies forming the gate lift and allowing simple installation along a single level;
v) the systems with the configuration and movement generally allow for opening greater than 90 degrees and particularly allowing about 180 degree openings and can be readily closed if opened over 90 degrees; and
vi) does not require complex linkage systems or exact precisions and therefore functions well in the practical world.

Other aspects of the invention are also disclosed.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 is a set of opposing lateral gate lifts in use in a closed position on a flatbed in accordance with a preferred embodiment of the present invention;

FIG. 2 is a set of opposing horizontal gate lifts in use in a closed position on a flatbed in accordance with a preferred embodiment of the present invention;

FIG. 3 is a perspective view of a gate lift of FIG. 1 with the gate lift being in an extended form when the gate lift in use is in a closed position such as in FIG. 1;

FIG. 4 is a perspective view of a gate lift of FIG. 1 with the gate lift being in a retracted form when the gate lift in use is in an open position such as in FIG. 1;

FIG. 5 is an overhead view of a gate lift of FIG. 1 with the gate lift being in an extended form when the gate lift in use is in a closed position such as in FIG. 1;

FIG. 6 is the cross-sectional view along A-A of a gate lift of FIG. 5 with the gate lift being in a extended form when the gate lift in use is in a closed position such as in FIG. 1;

FIG. 7 is a detail of a gate lift of FIG. 5 showing the outer slide rail of the gate lift of FIG. 5;

FIGS. 8 and 9 are diagrammatic side views of the relative positioning of the gate lifts of FIGS. 2 and 3 showing the comparison of the gate lifts between an extended form when the gate lift in use is in a closed position such as in FIG. 1 and a retracted form when the gate lift in use is in an open position such as in FIG. 1;

FIGS. 10 and 11 are diagrammatic perspective views of the relative positioning of the gate lifts of FIGS. 3 and 4 in a frame but excluding the linear drive;

FIG. 12 is a diagrammatic perspective view of the frame of FIGS. 10 and 11 included with other spaced vertical frame posts to form a box-like frame with FIGS. 13, 14, 15 and 16 showing details A, B, C, and D of FIG. 12 respectively;

FIGS. 17 to 23 are different views of the set of gate lifts of FIG. 1 in different operative positions to provide different opening positions of the lateral gates that the gate lifts are opening and closing; and

FIGS. 24 and 25 are diagrammatic side views of the relative positioning of the gate lifts of FIGS. 2 and 3 showing the comparison of the gate lifts between an extended form when the gate lift in use is in a closed position such as in FIG. 1 and a retracted form when the gate lift in use is in an open position such as in FIG. 1.

### DESCRIPTION OF PREFERRED EMBODIMENTS

It should be noted in the following description that like or the same reference numerals in different embodiments denote the same or similar features.

Referring to the drawings there is shown a gate lift 22 for pivotally raising and lowering a pivoting opening. The gate lift is for pivotally raising and lowering a gate and comprises a linear drive able to extend and retract linearly and having a pulley line connectable to the gate at a position spaced from the axis of the pivot of the gate and extending from the linear drive.

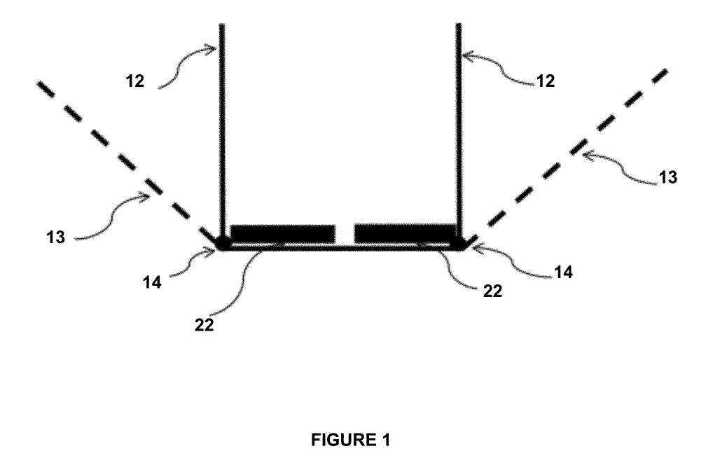

As shown in FIG. 1 the pivoting opening can be lateral gates 12 mounted substantially orthogonally to the plane of the floor with pivotal mount of the lateral gates such that lateral gates 12 can pivot around pivoting axes 14. The gate lift 22 mounted on the floor can move the lateral gates between a first closed position 12 and a second open position 13 and thereby allow lateral access.

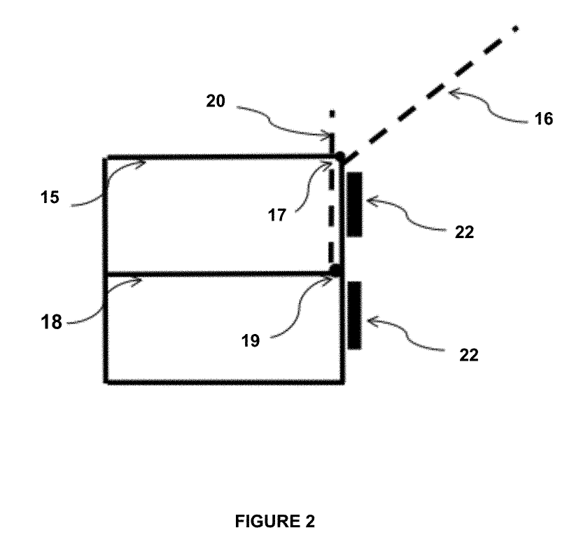

However as shown in FIG. 2 the pivoting opening can be horizontal gates 15, 18 mounted substantially orthogonally to the vertical plane of the fixed vertical wall and by the pivotal mount, can pivot around pivoting axes 17, 19. Gate lifts 22, externally mounted on the vertical wall can move the lateral gates between a first closed horizontal position 15, 18 and a second open position 16, 20 and thereby allow vertical access.

Referring in detail to the gate lift 22 as shown in 3 and 4 the gate lift 22 has a housing 31 mountable on a solid base. This can be a flatbed or vertical wall which could be on a vehicle or building. The gate lift 22 has a linear drive 41, 42 which is able to extend and retract linearly, whereby, in use, the gate lift mounted substantially orthogonally to the plane of the pivotal mount of the lateral gates can move the lateral gates away from the first closed position towards a second open position.

The gate lift 22 has a linear pulley having a slide 46, with at least one pulley wheel 47, 49 at either end of an intermediate part, mounted to a slide rail 45 which is fixedly mounted relative to the housing 31 to allow relative sliding movement of the linear pulley relative to the housing.

The gate lift 22 further has a pulley line 55 extending from the linear drive casing 41 and around the pulley wheels 47, 49 and connectable to the gate 12, 13 at a position spaced from the axis of the pivot P1 or P2 respectively of the gate 12, 13.

The linear drive is able to drive the linear pulley relative to the housing so as to extend and retract the pulley line linearly. The linear drive provides the pulley line extending from an overhang of the intermediate section and allowing the pulley line to hang from the end pulley 49 at height H1 above the height H2 of the linear drive and down to the end of the pulley line as it is connected to the gate at H3 so that it is connectable to the gate at a position spaced from the axis of the pivot of the gate P1 or P2 respectively. In this way the linear drive is able to drive the linear pulley relative to the housing so as to extend and retract linearly, whereby, in use, the gate lift mounted substantially orthogonally to the plane of the pivotal mount of the lateral gates can move the lateral gates between a first closed position to a second open position.

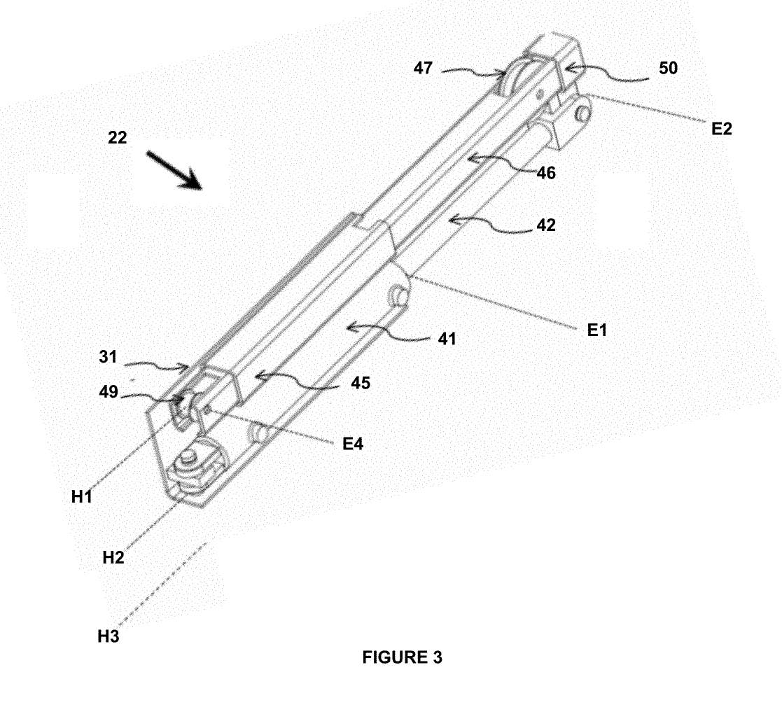

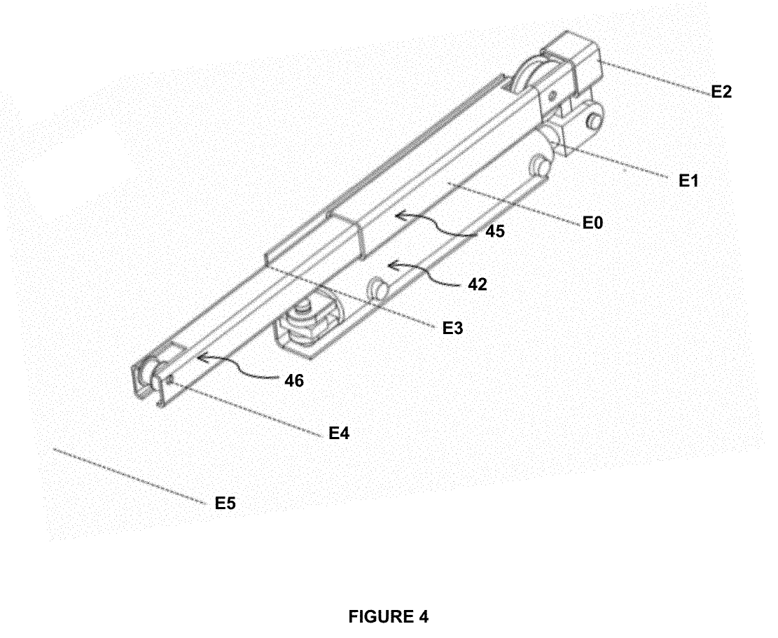

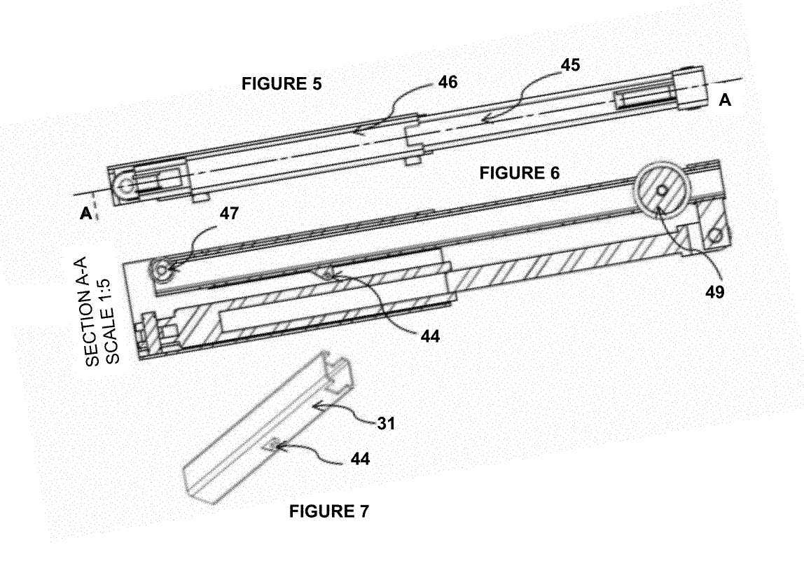

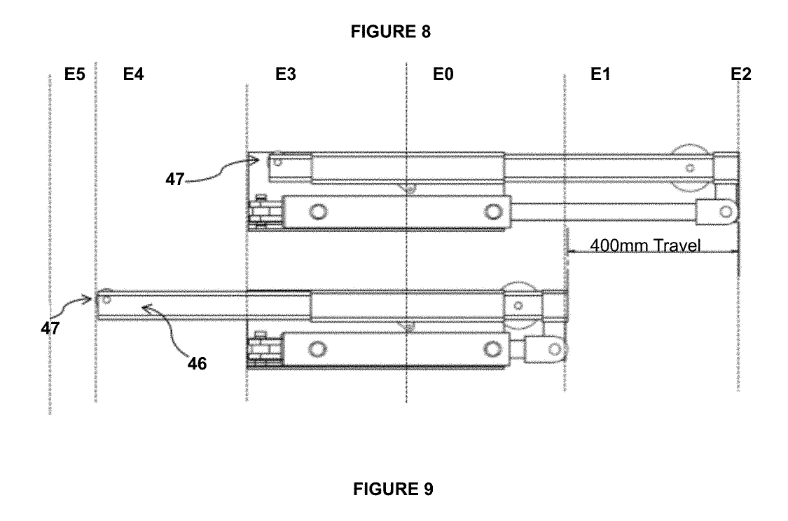

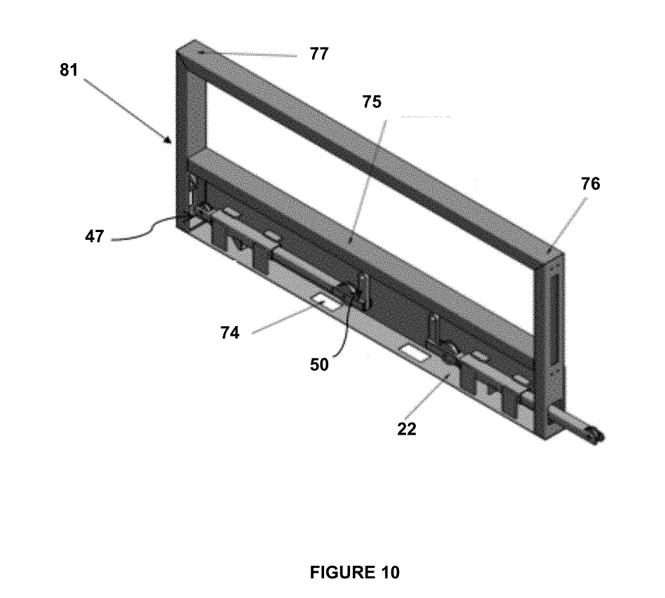

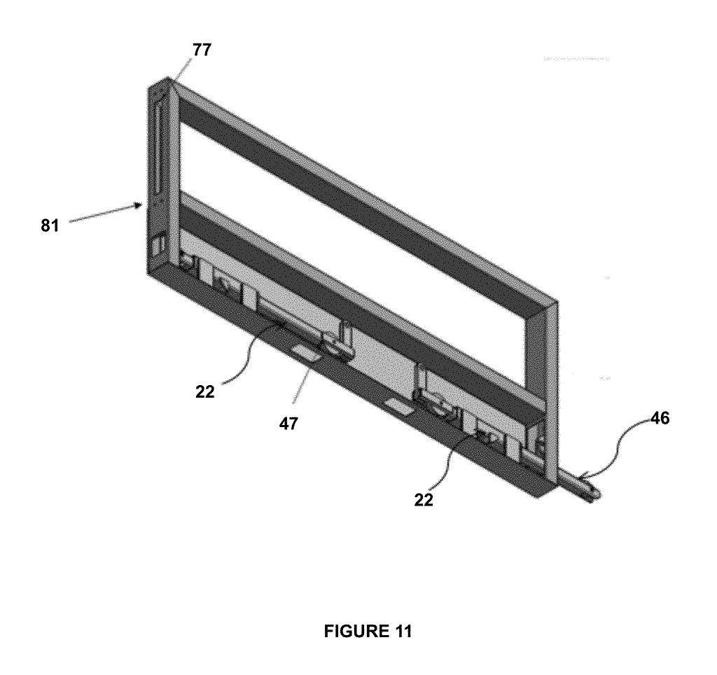

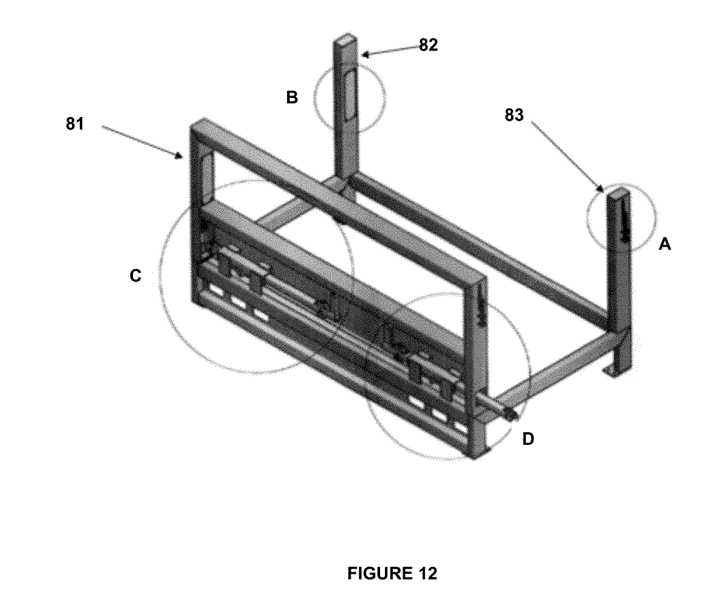

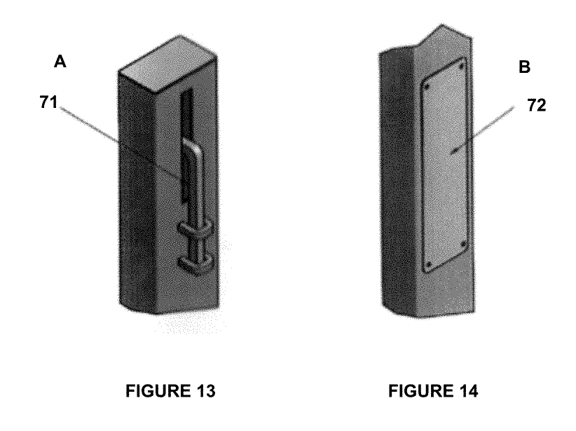

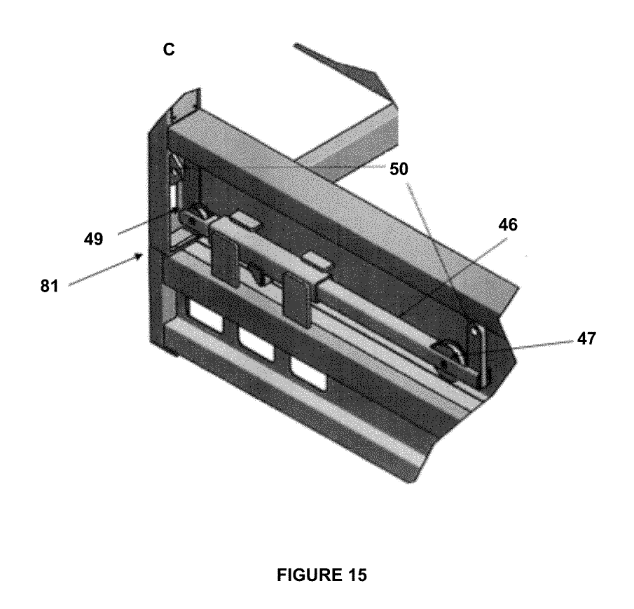

Referring to FIGS. 10 to 16 here is shown the use of a pair of gate lifts 22 mounted in a frame 81 so as to provide a prefabricated structure that can form one wall and provide control and movements of lateral walls 12, 23 connected to the pulley 55 extending from the pulley wheel 47. For simplification the frame 81 and gate lifts 22 can come without the linear drive being a hydraulic ram (as shown in drawings) but is connected in position to fittings 50 so as to complete the gate lift similarly to FIGS. 3 and 4.

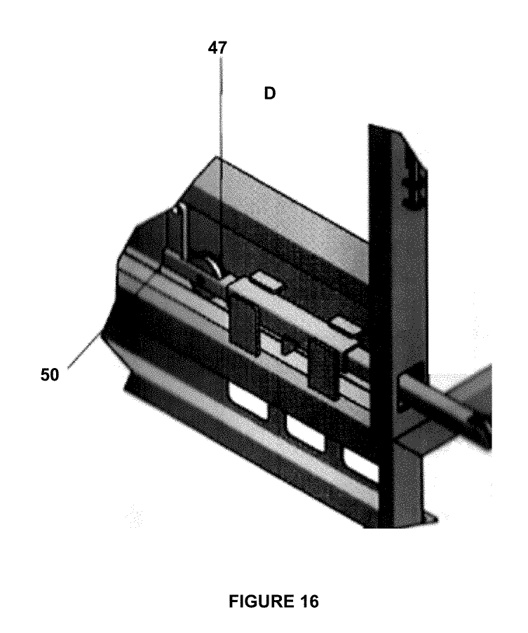

In particular form as shown in FIG. 12 the frame 81 is combined with spaced uprights 82, 83 connected by lateral connections to form a box like structure.

In use there is provided a method of pivotally raising and lowering a gate in which the linear drive is able to drive the linear pulley relative to the housing so as to extend and retract linearly. This method includes the steps of:
a. mounting the gates in a pivotal manner
b. providing a linear drive
c. providing a linear pulley
d. mounting the linear pulley so as to extend and retract linearly substantially orthogonally to the plane of the pivotal mount of the gates in a first closed position and from one side to an over pivot position on the other of the orthogonal plane of the pivotal mount of the gates;
e. connecting a pulley line from the linear drive pulley to the gate at a position spaced from the axis of pivotal of the gate
   whereby, in use, the gate lift mounted substantially orthogonally to the plane of the pivotal mount of the lateral gates can move the lateral gates greater than 90 degrees between a first closed position and a second open position.

In use there is a combination of effects including
a) the gate lift for pivotally raising and lowering a gate comprising a linear drive, wherein the linear drive is able to extend and retract linearly, whereby, in use, the gate lift mounted substantially orthogonally to the plane of the pivotal mount of the lateral gates can move the lateral gates between a first closed position to a second open position.
b) the linear pulley providing a pulley line extending from an overhang and connectable to the gate at a position spaced from the axis of the pivot of the gate; wherein the linear drive is able to drive the linear pulley relative to the housing so as to extend and retract linearly, whereby, in use, the gate lift mounted substantially orthogonally to the plane of the pivotal mount of the lateral gates can move the lateral gates between a first closed position to a second open position; and
c) the end of the pulley line extends and retracts beyond the intermediate part of the linear pulley at a distance which is a multiple of a stroke distance of the extension and retraction linearly of the linear drive.

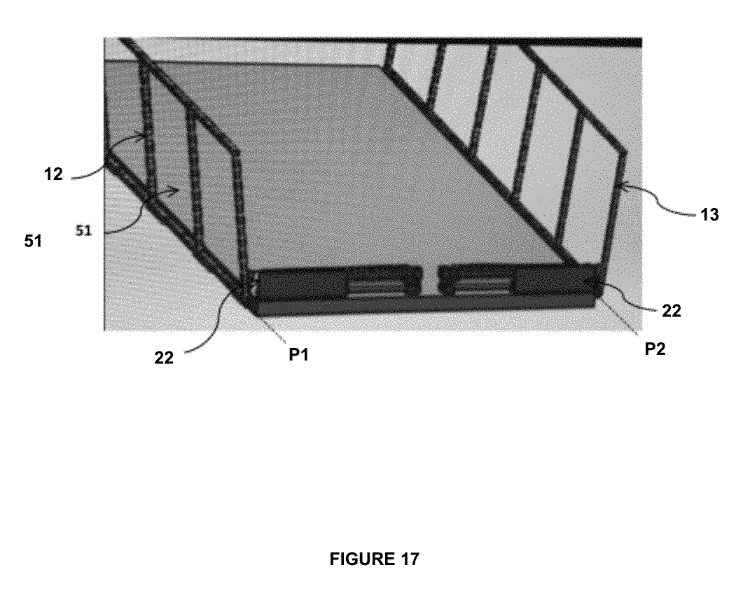

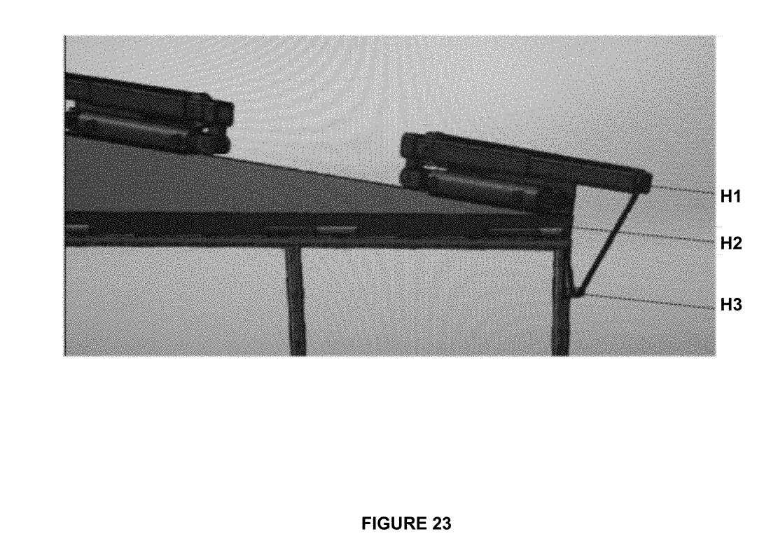

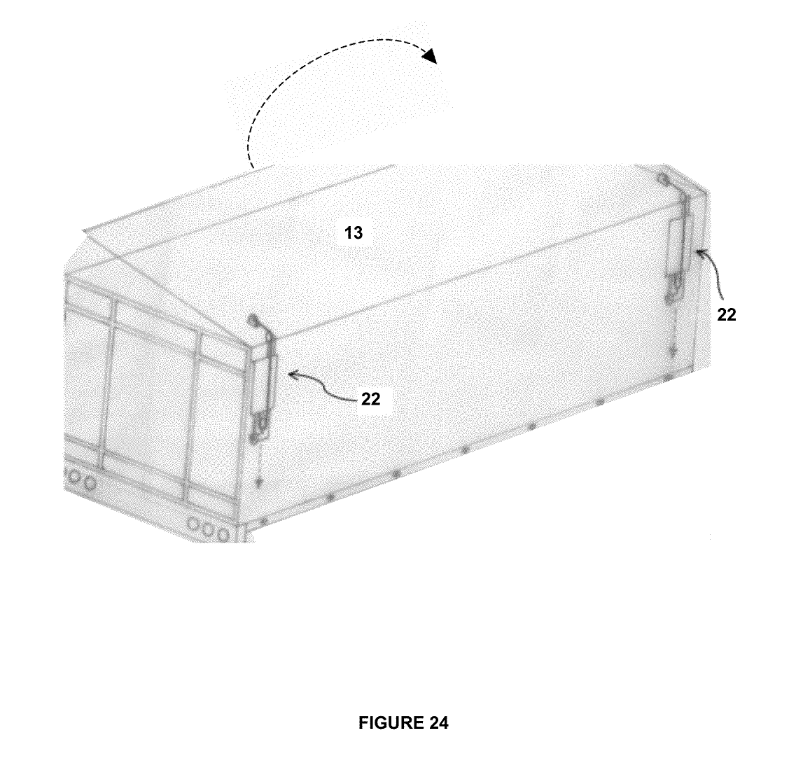

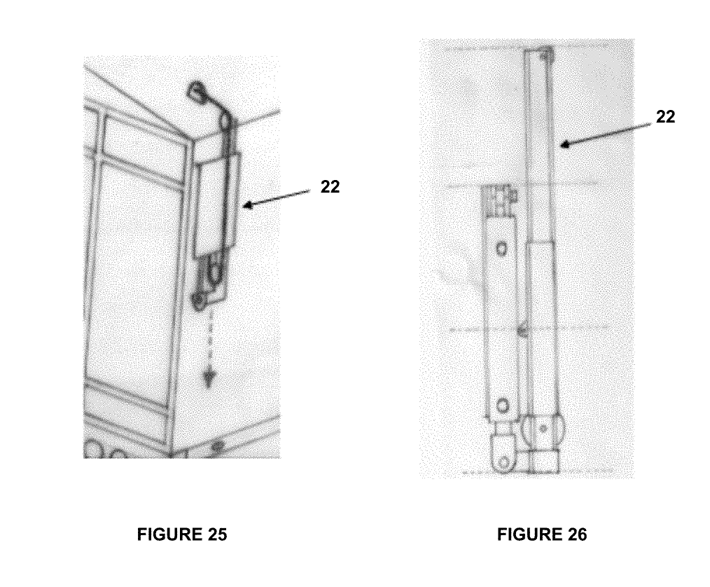

Referring to FIGS. 17 to 23 the solid base is a truck tray 51 which has lateral gates 12, 13 on either side and pivotally connected along the side of the truck tray 11. In this way the lateral gates 12, 13 can extend from a first closed position in a vertically upright position around the pivot P1 or P2 to a second open position 180 degrees around the pivot to a vertically downwardly extending position. Trucks therefore having a truck tray 51 can have loads supported on the truck tray and transportable with the lateral gates 12, 13 in upright position and accessible when the lateral gates 12, 13 are in a vertically downwardly extending position.

It is therefore necessary to have a means to pivotally raise and lower the lateral gates 12, 13 without taking substantial load receiving area of the truck tray 51.

This is achieved by a respective gate lift 22 being located at the longitudinal edge of the truck tray 51 whether that is at the rear of the truck or adjacent to the cabin of the truck. The gate lifts 22 are located substantially orthogonally to the plane of the pivotal mount of the gates in a first closed position and from one side to the other of the orthogonal plane of the pivotal mount of the gates.

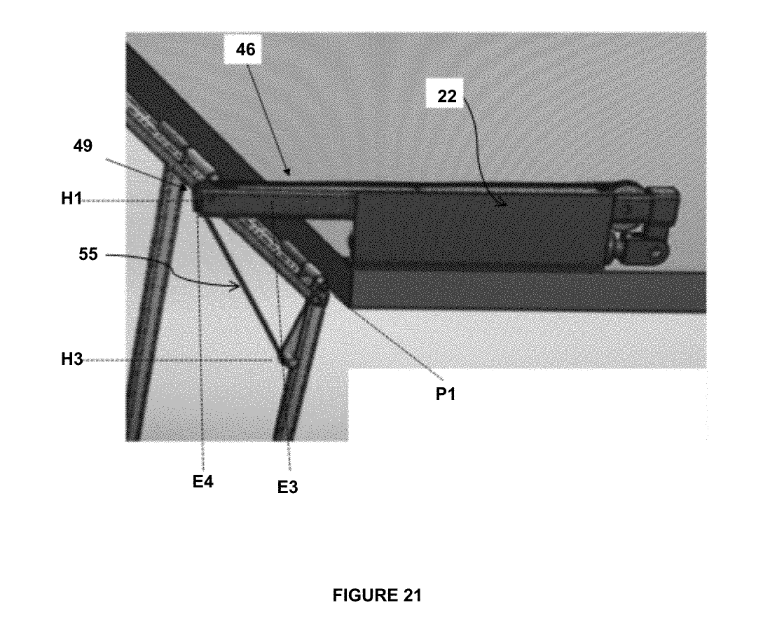

Referring to FIGS. 21, 22 and 23 there is shown a gate lift 22 with a linear drive having a casing fixedly mounted relative to the housing. The linear drive is in the form of a piston chamber 41 with a piston 42 that extends therefrom in a linear arrangement. The gate lift 20 further includes a linear pulley having a slide 46 with at least one pulley wheel 47, 49 at either end and an intermediate part mounted to a slide rail 45 which is fixedly mounted relative to the housing 31 to allow relative sliding movement of the linear pulley relative to the housing.

A pulley line 55 extends from the mounting point on the linear drive casing 41 at position E0 and around the pulley wheels 47, 49 located at positions E2 and E4 at either ends of the linear pulley. The pulley line is connectable to the gate at a position spaced from the axis of the pivot of the gate.

Therefore it can be seen in FIGS. 21, 22 and 23 of the pulley line begins at E0 from the connection on the piston casing 41 to the larger pulley wheel 47 at E2 at one end of the intermediate part of the linear pulley formed by the inner slide 46. The pulley line then extends around the pulley wheel 47 and travels alongside the inner slide 46 until engaging and partially extending around smaller pulley wheel 49 at location E4 at the other end of the intermediate part of the linear pulley formed by the inner slide 46. The pulley line can then extend beyond the intermediate part of the linear pulley formed by the inner slide 46 to position E5.

Clearly the relative positions between E2 and E4 remains constant as the intermediate part of the linear pulley formed by the inner slide 46 does not alter configuration. However there is the slide of intermediate part of the linear pulley formed by the inner slide 46 into the outer slide rail 45 that changes the distance between E0 and E2. There is further the extension and retraction of the piston rod 42 from the piston chamber 41 that allows the alteration of the distance between E1 and E2.

With the particular interconnection of the linear drive to the linear pulley and the pulley line extending from the initial point E0 at 44 and around the large pulley wheel 47 and around the small pulley wheel 49 there is the resulting variation of distance that the pulley line extends beyond E4 at the end of the intermediate part of the linear pulley formed by the inner slide 46 to the end of the pulley line at E5.

The pulley line is connected at E5 to the lateral gate 20, 21 at a spaced distance from the pivotal connection of the lateral gate 20, 21.

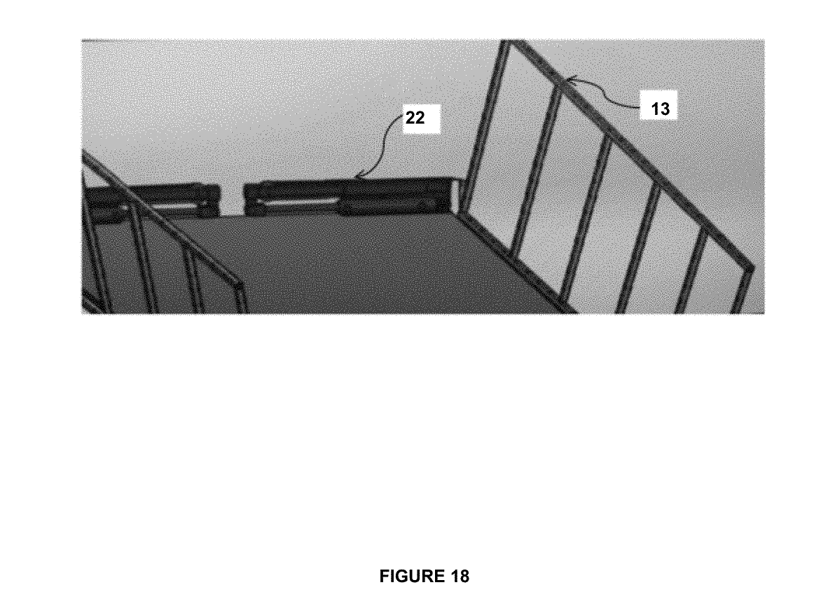

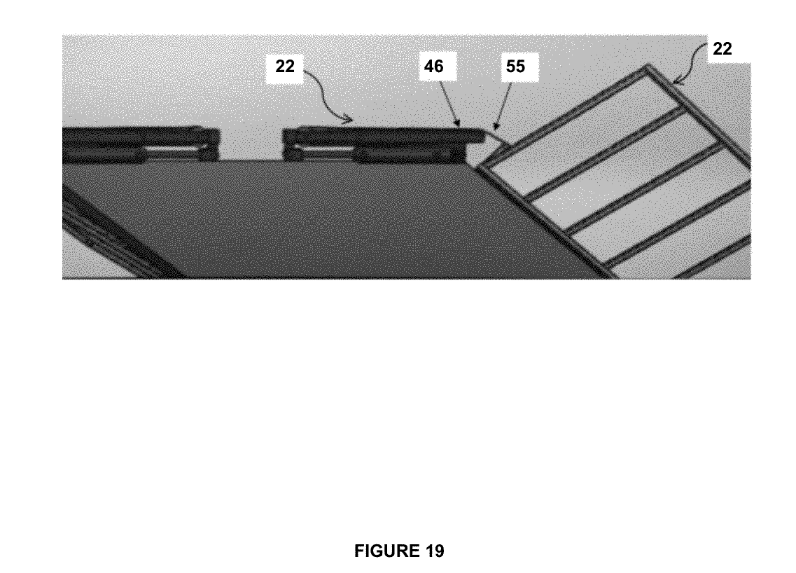

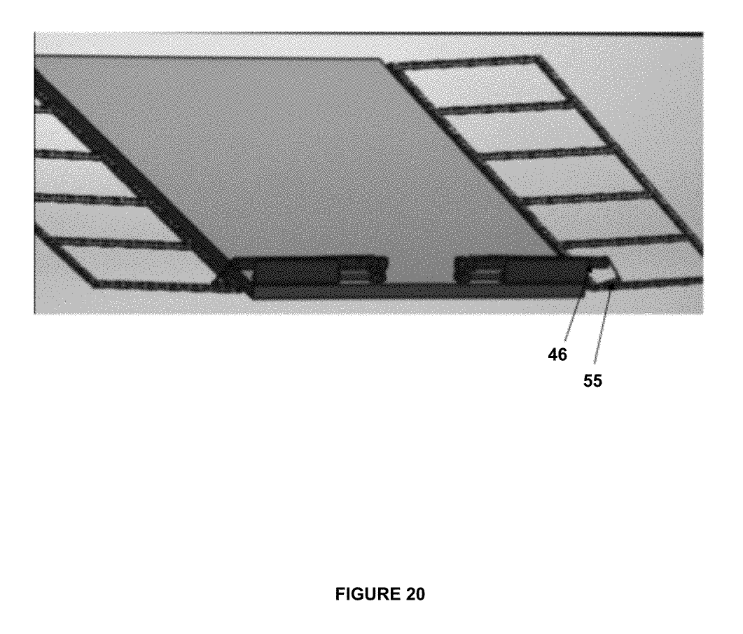

Looking at the operation of the combination of the linear drive, the linear pulley, and the pulley line to provide different final effect on the lateral gates as per the following:

| | | | | |
|---|---|---|---|---|
| FIG. 17 | Lateral Gates | Linear drive fully | Linear pulley fully | Pulley line |
| | closed | extended | retracted | retracted |
| FIG. 18 | Lateral Gates | Linear drive | Linear pulley | Pulley line |
| | partially open | partially retracted | partially | partially |
| | | | overhanging | extended |
| FIG. 19 | Lateral Gates | Linear drive further | Linear pulley | Pulley line |
| | further open | retracted | further overhanging | further extended |
| FIG. 20 | Lateral Gates | Linear drive fully | Linear pulley fully | Pulley line fully |
| and FIG. 21 | open | retracted | overhanging | extended |

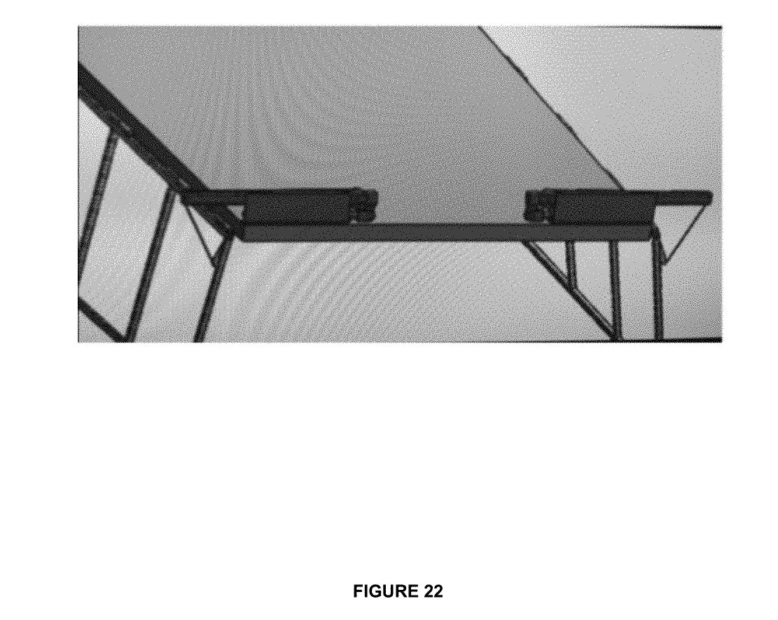

In use, the gate lift 22 mounted substantially orthogonally to the plane of the pivotal mount of the lateral gates 12, 13 can move the lateral gates between a first closed position and a second open position as shown by:

| | | | | |
|---|---|---|---|---|
| FIG. 17 | Lateral Gates | Linear drive | Linear pulley fully | Pulley line |
| and FIG. 3 | closed | extended piston | retracted at E4 | retracted |
| | | casing E1 to E3 = | | E5 − E4 = |
| | | Y plus piston | | minimum |
| | | extension E1 to E2 = | | |
| | | X | | |
| FIG. 22 | Lateral Gates | Linear drive fully | Linear pulley fully | Pulley line fully |
| and FIG. 21 | open | retracted E1 to E2 = | overhanging | extended |
| and FIG. 4 | | minimum | E4 − E3 = | E5 − E4 = |
| | | | maximum | maximum= |
| | | | | 2 times extension |
| | | | | E1 to E2 = 2*X |

A substantial advantage of the invention is provided in one form by one or more of a combination of factors including:
a) a linear drive so that there is a low profile and minimal area of the load storage area taken
b) an overhanging of the linear pulley so that there is an over pivot movement of the lateral gates away from the pivotal mount of the lateral gates, this further initiates the movement of the lateral gates from a closed vertically extending position.
c) A connection of the pulley line to the lateral gates at position spaced from the pivotal mount of the lateral gates, this further initiates the movement of the lateral gates, from a fully open downwardly extending position
d) an overlapping of the pulley line so that the movement of the linear pulley means is amplified and therefore a smaller linear drive with smaller piston stroke required
e) a variation in the size of the pulley wheels at either end of the linear pulley means so as to amplify the pulley effect.

Other variations would be readily understood by persons skilled in the art and are readily disclosed to such persons by way of the current illustrations without detailing each and are therefore clearly included within the scope of this invention.

The apparatus can be used on pivotally hinged arrangements in substantially orthogonal alignment to the:
a) Individually
b) In opposed linear arrangement
c) In spaced parallel arrangement
d) Or a combination thereof

### EXAMPLE 1

### Hinged Rear Tail of Truck

### EXAMPLE 2

### Hinged Side Walls of a Truck

### EXAMPLE 3

### Hinged Windows

### EXAMPLE 4

### Hinged Vehicle Covers

### Interpretation

### Meanings:

In the specification including the claims the following terms are to have the following meanings.

“linear drive” is to include drives that allow movement along an elongated length including but not limited to piston drive.

“over pivot” is to mean that for an article that is pivoting around a substantially horizontal pivot axis from a support body the support or item is in “an over pivot position” if it has moved from a side of the support body to over the other side of the pivot axis away from the support body.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the gate lift industries.

1-3. (canceled)

4. A gate lift for pivotally raising and lowering a gate comprising
i. a housing mountable on a solid base;
ii. a linear drive able to extend and retract linearly and having a casing fixedly mounted relative to the housing;
iii. a linear pulley having a slide with at least one pulley wheel at either end and an intermediate part mounted to a slide rail which is fixedly mounted relative to the housing to allow relative sliding movement of the linear pulley relative to the housing;
iv. a pulley line connectable to the gate at a position spaced from the axis of the pivot of the gate and extending from the linear drive and extending from the linear drive casing and around the pulley wheels and connectable to the gate at a position spaced from the axis of the pivot of the gate;
wherein the linear drive is able to drive the linear pulley relative to the housing so as to extend and retract linearly;
whereby, in use, the gate lift mounted substantially orthogonally to the plane of the pivotal mount of the lateral gates can move the lateral gates greater than 90 degrees between a first closed position to a second open position.

5-6. (canceled)

7. A gate lift according to claim 4 wherein the linear drive is a piston drive and includes a piston chamber fixedly mounted relative to the housing.

8. (canceled)

9. A gate lift according to claim 4 wherein the intermediate part of the linear pulley has a slide with a pulley wheel mounted at either end at fixed spacing.

10. A gate lift according to claim 9 wherein the stroke of the piston rod of the piston drives the slide of the intermediate part of the linear pulley.

11. A gate lift according to claim 10 wherein the end of the piston rod of the piston is connected to the intermediate part of the linear pulley.

12. A gate lift according to claim 11 wherein the end of the pulley line extends and retracts beyond the intermediate part of the linear pulley at a distance greater than the stroke of the piston rod of the linear drive.

13. A gate lift according to claim 11 wherein the end of the pulley line extends and retracts beyond the intermediate part of the linear pulley at a distance which is a multiple of the stroke of the piston rod of the linear drive.

14. A gate lift according to claim 11 wherein the end of the pulley line extends from the piston chamber and around the pulley wheel at end of the intermediate part of the linear pulley to thereby extend beyond the intermediate part of the linear pulley at a distance substantially corresponding to twice the stroke of the piston rod of the linear drive.

15. A gate lift according to claim 11 wherein the end of the pulley line extends from the piston chamber and around the pulley wheels at end of the intermediate part of the linear pulley more than once to thereby extend the pulley line beyond the intermediate part of the linear pulley at a distance greater than twice the stroke of the piston rod of the linear drive.

16. (canceled)

17. A gate lift according to claim 11 wherein the opening pivotally of the lateral gates between a first closed position to a second open position extends about 180 degrees.

18. A gate lift according to claim 11 wherein the opening pivotally of the lateral gates between a first closed position to a second open position extends from an upright position to a downwardly extending position.

19. A gate lift system including a gate mounted pivotally raising and lowering a gate comprising:
i. a flatbed
ii. a gate mounted pivotally along a side of the flatbed; and
iii. a gate lift for pivotally raising and lowering the gate.

20. A gate lift system, according to claim 19 wherein gate is mounted pivotally to a rear swinging tailgate on a tipper.

21. A gate lift system, according to claim 19 wherein the mechanism is mounted on top of a tipping body at the rear to open tailgate before raising hoist so as to control emptying of load.

22. A gate lift system, according to claim 19 for pivotally raising and lowering a gate comprising a linear drive; wherein the linear drive is able to extend and retract linearly, whereby, in use, the gate lift mounted substantially orthogonally to the plane of the pivotal mount of the lateral gates can move the lateral gates between a first closed position to a second open position.

23. A gate lift system, according to 19, for pivotally raising and lowering a gate includes a linear pulley providing a pulley line extending from an overhang and connectable to the gate at a position spaced from the axis of the pivot of the gate; wherein the linear drive is able to drive the linear pulley relative to the housing so as to extend and retract linearly, whereby, in use, the gate lift mounted substantially orthogonally to the plane of the pivotal mount of the lateral gates can move the lateral gates between a first closed position to a second open position.

24. A gate lift system, according to 19 for pivotally raising and lowering a gate wherein the end of the pulley line extends and retracts beyond the intermediate part of the linear pulley at a distance which is a multiple of a stroke distance of the extension and retraction linearly of the linear drive.

25-27. (canceled)

28. A method of pivotally raising and lowering a gate including the steps of:
i. mounting the gates in a pivotal manner
ii. providing a linear drive
iii. providing a linear pulley
iv. mounting the linear pulley so as to extend and retract linearly substantially orthogonally to the plane of the pivotal mount of the gates in a first closed position and from one side to an over pivot position on the other of the orthogonal plane of the pivotal mount of the gates;
v. connecting a pulley line from the linear drive pulley to the gate at a position spaced from the axis of pivotal of the gate
whereby, in use, the gate lift mounted substantially orthogonally to the plane of the pivotal mount of the lateral gates can move the lateral gates greater than 90 degrees between a first closed position and a second open position.

29. A method of pivotally raising and lowering a gate according to claim 28 comprising a linear drive able to extend and retract linearly, whereby, in use, the gate lift mounted substantially orthogonally to the plane of the pivotal mount of the lateral gates can move the lateral gates between a first closed position to a second open position.

30. A method of pivotally raising and lowering a gate according to claim 28 comprising a linear pulley providing a pulley line extending from an overhang and connectable to the gate at a position spaced from the axis of the pivot of the gate; wherein the linear drive is able to drive the linear pulley relative to the housing so as to extend and retract linearly, whereby, in use, the gate lift mounted substantially orthogonally to the plane of the pivotal mount of the lateral gates can move the lateral gates between a first closed position to a second open position.

31. A method of pivotally raising and lowering a gate according to claim 30 comprising the end of the pulley line extending and retracting beyond the intermediate part of the linear pulley at a distance which is a multiple of a stroke distance of the extension and retraction linearly of the linear drive.

32. A gate lift, according to claim 4, for pivotally raising and lowering a gate wherein the end of the pulley line extends and retracts beyond the intermediate part of the linear pulley at a distance which is a multiple of a stroke distance of the extension and retraction linearly of the linear drive.
